(19) United States
(12) Patent Application Publication
(10) Pub. No.: US 2026/0317632 A1
(43) Pub. Date: Oct. 15, 2026

(54) CARBON REDUCTION TYPE SAGD PLANT SYSTEM USING GREEN HYDROGEN

(71) Applicant: Koms Co. Ltd., Busan (KR)

(72) Inventors: Hyun Kook KIM, Busan (KR); Hyeon Seong CHOI, Busan (KR); Sang Ho CHA, Busan (KR)

(73) Assignee: Koms Co. Ltd., Busan (KR)

(21) Appl. No.: 18/879,221

(22) PCT Filed: Dec. 10, 2024
(86) PCT No.: PCT/KR2024/020119

§ 371 Date: Dec. 26, 2024

(30) Foreign Application Priority Data
Dec. 22, 2023 (KR) 10-2023-0189311

(51) Int. Cl. C10G 1/04; B01D 17/02; C02F 1/24; C02F 1/40; C02F 101/32; C02F 103/10; C10G 33/06; C25B 1/04; C25B 15/08; E21B 43/24; E21B 43/34

(52) U.S. Cl. CPC C10G 1/04; B01D 17/0208; C02F 1/24; C02F 1/40; C10G 33/06; C25B 15/085; E21B 43/2406; E21B 43/34; C02F 2101/32; C02F 2103/10; C10G 2300/1033; C25B 1/04

(57) ABSTRACT

The present invention relates to a carbon reduction type SAGD plant system using green hydrogen, which substitutes for expanding solvent steam-assisted gravity drainage (ES-SAGD) which is a method using an additive (a solvent or the like) in order to reduce steam and natural gas and to lower a steam-oil ratio (SOR) having an influence on generation of environmental pollution, upon recovering an oil component from oil sands reserved under the ground, based on a steam-assisted gravity drainage (SAGD) technology most common among methods of recovering bitumen from oil sands, thereby being capable of recovering bitumen while greatly reducing greenhouse gas emissions conventionally pointed out as a most serious problem, using only a mixture of eco-friendly hydrogen produced through a water electrolysis device with natural gas and steam.

### TECHNICAL FIELD

The present invention relates to a carbon reduction type SAGD plant system, and more particularly to technology substituting for expanding solvent steam-assisted gravity drainage (ES-SAGD) which is a method using an additive (a solvent or the like) in order to reduce steam and natural gas and to lower a steam-oil ratio (SOR) having an influence on generation of environmental pollution, upon recovering an oil component from oil sands reserved under the ground, based on a steam-assisted gravity drainage (SAGD) technology most common among methods of recovering bitumen from oil sands. The present invention is technology associated with carbon reduction type SAGD plant system using green hydrogen, which is capable of recovering bitumen while greatly reducing greenhouse gas emissions conventionally pointed out as a most serious problem, using only a mixture of eco-friendly hydrogen produced through a water electrolysis device with natural gas and steam.

### BACKGROUND ART

Due to recent oil price rise, Russian invasion of Ukraine, etc., necessity of oil is again being highlighted, and unconventional oil produced in an oil sand plant, etc. under extreme environmental conditions is being again highlighted.

In particular, various methods for recovering bitumen, which is a petroleum product consisting of natural hydrocarbon compounds, that is, a black semi-solid or liquid phase material soluble in carbon oxide or liquid-phase hydrocarbon at room temperature, and is obtained as a residue from petroleum distillation, are being employed. In association with these methods, however, environmental pollution such as greenhouse gas emissions, etc. is continuously becoming an issue due to oil production characteristics. For this reason, a long-term environmental pollution reduction plan is required. This may be an important factor determining continuity of the oil sands business.

SAGD methods, which occupy 80% or more of current bitumen production methods, use a large amount of water (steam) and gas which are main causes of environmental pollution and greenhouse gas emissions. In order to reduce use of water (steam) and gas, expanding solvent SAGD (ES-SAGD) that is a method in which high-grade refined oil, such as a solvent or the like, is mixed in order to reduce an amount of steam is currently used.

That is, in steam generation and bitumen processing procedures, hazardous substances such as H₂S, etc. may be produced, and a large amount of water is required for steam generation. In such situations, a well or a pond is mainly utilized for supply of water. In such a method, however, an amount of water corresponding to 3 times or more the amount of oil to be produced is necessary, and pollution inevitably occurs, in spite of treatment of exhausted water.

Since use of a large amount of water in the SAGD method becomes a main cause of environmental pollution, expanding solvent SAGD (ES-SAGD), in which a high-grade refined oil such as a solvent or the like is mixed to reduce an amount of steam, is often employed in order to reduce an amount of steam.

In association with application of SAGD technology or ES-SAGD technology for recovery of bitumen from oil sands reserved under the ground, therefore, a method capable of enhancing the quality of bitumen through hydrogenation of injected hydrogen while greatly reducing greenhouse gas emissions, as compared to injection of a mixture of hydrogen and natural gas and injection of an additive such as a solvent, CO₂ or the like, is currently required.

### DISCLOSURE

### Technical Problem

Therefore, the present invention has been made in view of the above problems, and it is an object of the present invention to provide a carbon reduction type SAGD plant system using green hydrogen, which is capable of recovering bitumen while greatly reducing greenhouse gas emissions, using a mixture of hydrogen produced through a water electrolysis device with natural gas and steam.

### Technical Solution

In accordance with an aspect of the present invention, the above and other objects can be accomplished by the provision of a plant system for recovering bitumen of an oil sands mining region, using green hydrogen, including a first water treatment module configured to remove impurities from make-up water, thereby producing purified water, a boiler module configured to heat the purified water, thereby producing steam, a hydrogen production module configured to electrolyze the purified water using electric power, thereby producing hydrogen, an injection well configured to supply the steam to an inside of the oil sands mining region, a hydrogen supplier configured to supply a part of the hydrogen produced in the hydrogen production module to the inside of the oil sands mining region, a producer well configured to allow recovery of bitumen and gas from a lower portion of the oil sands mining region therein, a first separator configured to separate a gas component and bitumen in the producer well, and an oil-water separation module configured to separate a water component from the bitumen emerging from the first separator.

In this case, the plant system may further include a second separator configured to produce reformed hydrogen using the gas component emerging from the first separator. The boiler module may be configured to use, as fuel, a part of the hydrogen produced in the hydrogen production module.

In addition, the plant system may further include a first gas mining module configured to receive natural gas from outside, to be connected to the hydrogen supplier, to mix the natural gas and the hydrogen supplied from the hydrogen supplier at a predetermined ratio, and to supply a resultant mixture to the inside of the oil sands mining region, and a second gas mixing module configured to mix natural gas separated in the second separator and a part of the hydrogen produced in the hydrogen production module at a predetermined ratio, and to supply a resultant mixture as fuel of the boiler module.

In addition, the plant system may further include a second water treatment module configured to treat water separated in the oil-water separation module and to supply the treated water to the boiler module and the hydrogen production module.

In addition, the plant system may further include a diluent treatment module including a diluent tank configured to store a diluent, a diluent supplier configured to supply the diluent to the oil-water separation module, and a diluent recovery unit configured to recover a diluent from bitumen emerging from the oil-water separation module and to supply the recovered diluent to the diluent tank.

### Advantageous Effects

Through the present invention, it may be possible to substitute for expanding solvent steam-assisted gravity drainage (ES-SAGD) which is a method using an additive (a solvent or the like) and, as such, to efficiently recover bitumen from oil sands while greatly reducing greenhouse gas emissions conventionally pointed out as a most serious problem, using only a mixture of eco-friendly hydrogen produced through a water electrolysis device with natural gas and steam.

In particular, it may be possible to reduce a carbon dioxide generation rate by 20 to 40% through production of green hydrogen, thereby reducing a carbon dioxide tax according to a carbon credit. In addition, wide utility such as NOₓ reduction through hydrogen reforming, plant basic power consumption through use of a hydrogen fuel cell and produced hydrogen, etc. may be provided.

In addition, it may be possible to persistently store hydrogen in an underground cave, in which production of bitumen in an SAGD manner has been completed, and to recover the stored hydrogen. Accordingly, the present invention may greatly contribute to realization of power to gas (P2G).

### DESCRIPTION OF DRAWINGS

FIG. 1 is a concept diagram of ES-SAGD production according to the prior art.

FIG. 2 is a diagram of an ES-SAGD production system according to the prior art.

FIGS. 3 and 4 are diagrams of an SAGD production system using hydrogen in accordance with an embodiment of the present invention.

FIGS. 5 and 6 are diagrams of an SAGD production system using hydrogen in accordance with another embodiment of the present invention.

### BEST MODE

Hereinafter, a configuration of a carbon reduction type SAGD plant system using green hydrogen in accordance with the present invention will be described in detail with reference to the accompanying drawings.

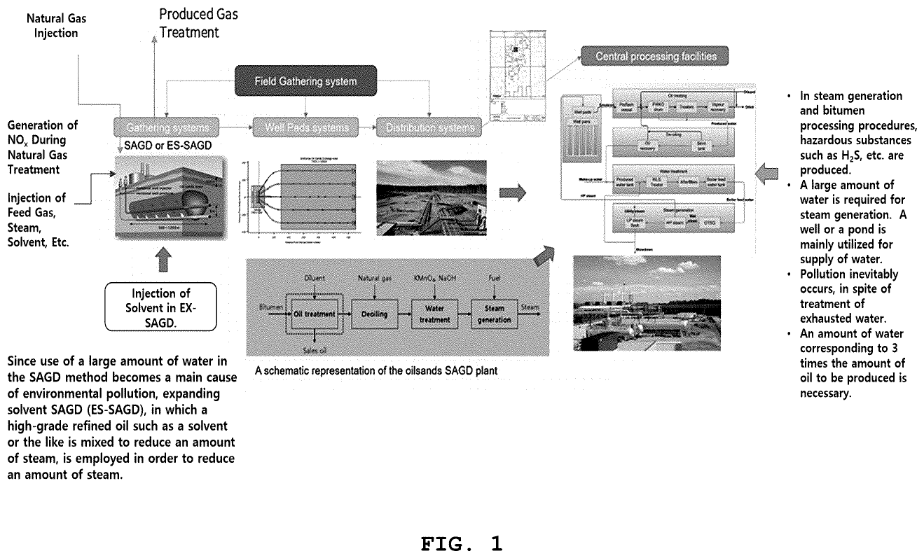

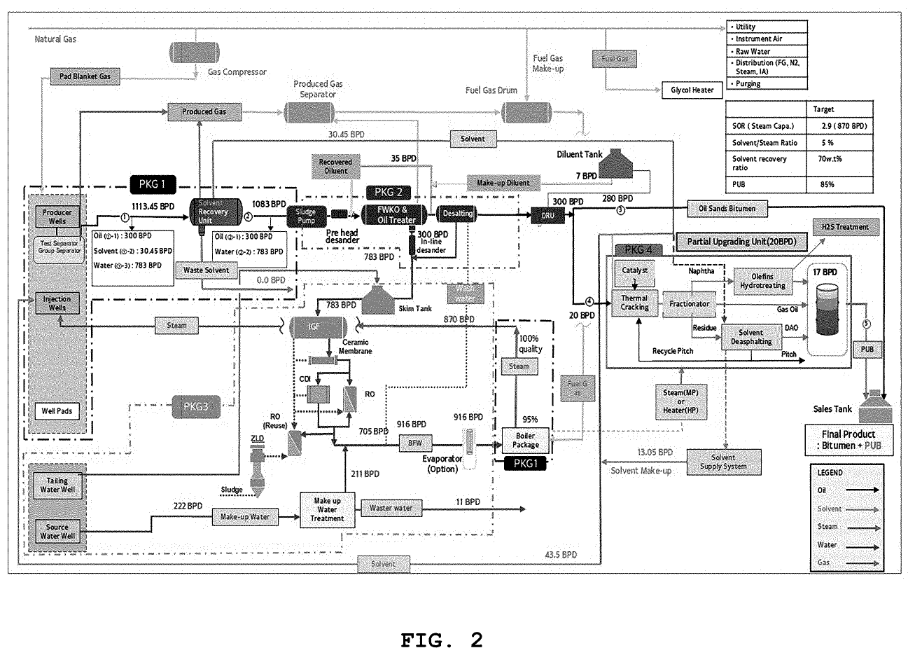

FIG. 1 is a concept diagram of ES-SAGD production according to the prior art. FIG. 2 is a diagram of an ES-SAGD production system according to the prior art.

In an SAGD system, a series of complex procedures are required in order to mine bitumen coagulated in underground oil sands and to use the mined bitumen as crude oil. In this case, great amounts of water, electricity, gas, etc. are consumed, and environmental pollution caused by steam, gas, etc. in a treatment procedure occurs.

In particular, factors having the greatest influence on generation of greenhouse gases are steam and methane of natural gas. As an SOR, which is a steam-oil production ratio, and a GOR, which is a gas-oil production ratio, are lowered, there are advantages in terms of environmental pollution and economics. In order to lower the SOR and the GOR, an in-situ method (an underground recovery method) has recently been applied as an ES-SAND method of mixing a solvent with steam, thereby enhancing mining productivity while reducing use of natural gas.

An ES-SAGD plant is similar to the SAGD system, and includes an injection well, which gas, steam, and a solvent are injected, and a production well configured to recover bitumen from underground, for underground recovery. In addition, the ES-SAGD plant includes a well pad device as a basic separation/treatment device, and an oily water separator, a water treatment device, a boiler package configured to produce steam, a device configured to inject and recover a solvent, etc. of a central processing facility (CPF). If necessary, partial reformation treatment is also performed.

In addition, water, which is a steam production source, is obtained from source water obtained in a natural environment and tailing water obtained after treatment of oil sands. The obtained water is supplied after being water-treated into boiler fresh water (BFW). That is, continuous production of water is required for supply of BFW. A sufficient amount of wafer for production of hydrogen may be secured based on water electrolysis in accordance with characteristics of the present invention.

The present invention uses a method of recovering bitumen by mixing hydrogen produced through a water electrolysis device with natural gas in order to reduce greenhouse gas pointed out as a most serious problem in association with recovery of bitumen from oil sands. That is, the present invention substitutes for expanding solvent steam-assisted gravity drainage (ES-SAGD), which is a method of using steam, natural gas, and an additive (a solvent or the like) for lowering of a steam-oil ratio (SOR) having influence on generation of environmental pollution, upon recovering an oil component from oil sands reserved under the ground, based on steam-assisted gravity drainage (SAGD) technology most common among methods of recovering bitumen from oil sands. The present invention recovers bitumen while greatly reducing greenhouse gas emissions through use of only a mixture of hydrogen, which is an eco-friendly raw material, with natural gas, and steam. The reason why the hydrogen is efficient in the SAGD method is because the hydrogen has a higher heat capacity than that of steam. That is, the hydrogen may potentially transfer a greater amount of heat to a reservoir, thereby enhancing an oil recovery rate. In accordance with in-situ combustion, the hydrogen reacts with oil in the reservoir, thereby generating heat. In this regard, the hydrogen may be used for in-situ combustion which is a procedure establishing conditions for promoting flow of oil. In addition, hydrogen combustion may potentially reduce emission of greenhouse gas associated with an extraction process because only water vapor is produced as a by-product in the hydrogen combustion.

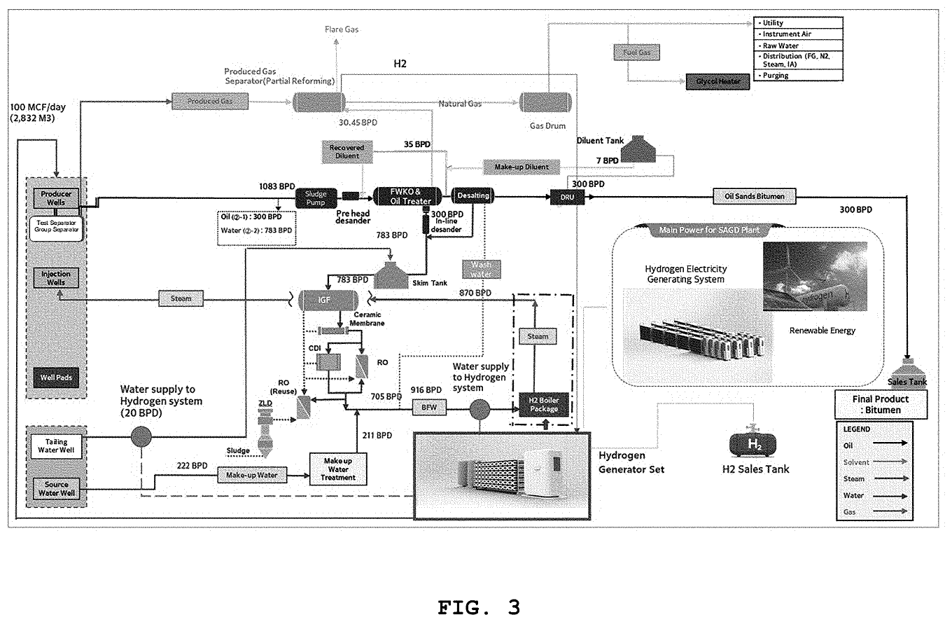

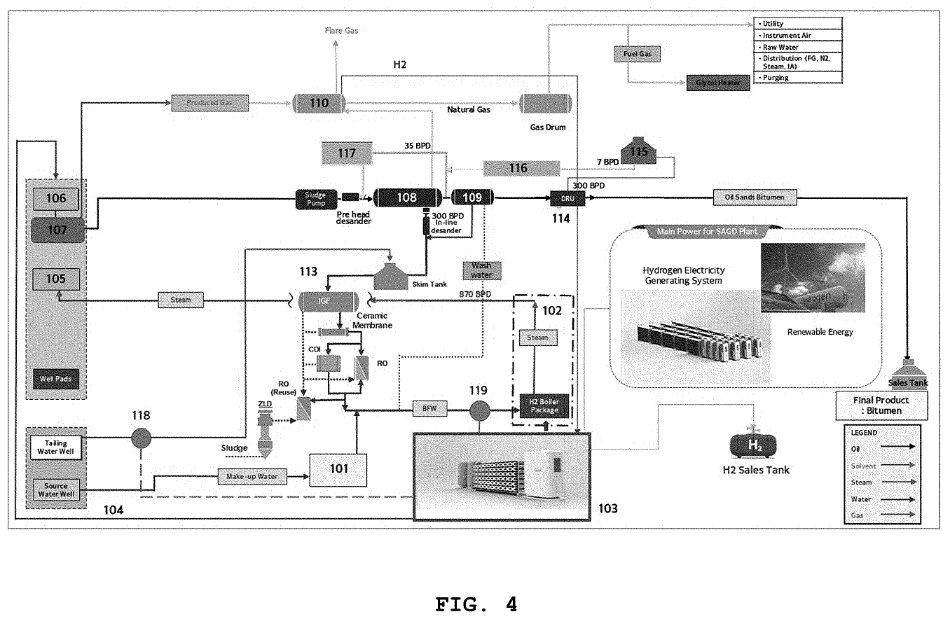

FIGS. 3 and 4 are diagrams of an SAGD production system using hydrogen in accordance with an embodiment of the present invention. In accordance with the present invention, a plant system configured to recover bitumen from an oil sands mining area basically supplies steam and hydrogen to the oil sands mining area, thereby recovering bitumen. In addition, the plant system may produce steam in an eco-friendly manner using a hydrogen boiler operating through direct supply of hydrogen thereto, which has recently become commercially available, in place of a steam generator using traditional natural gas.

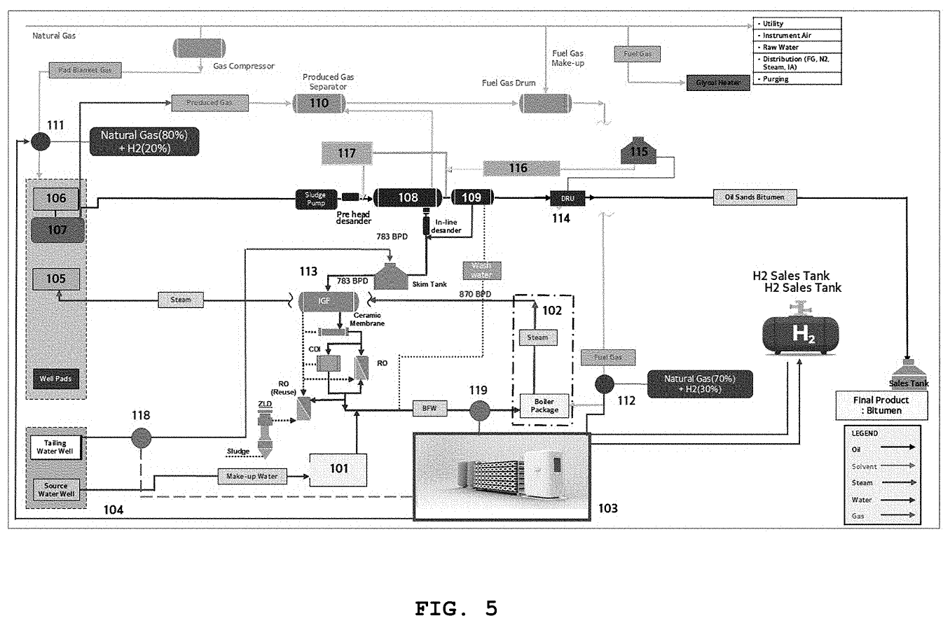

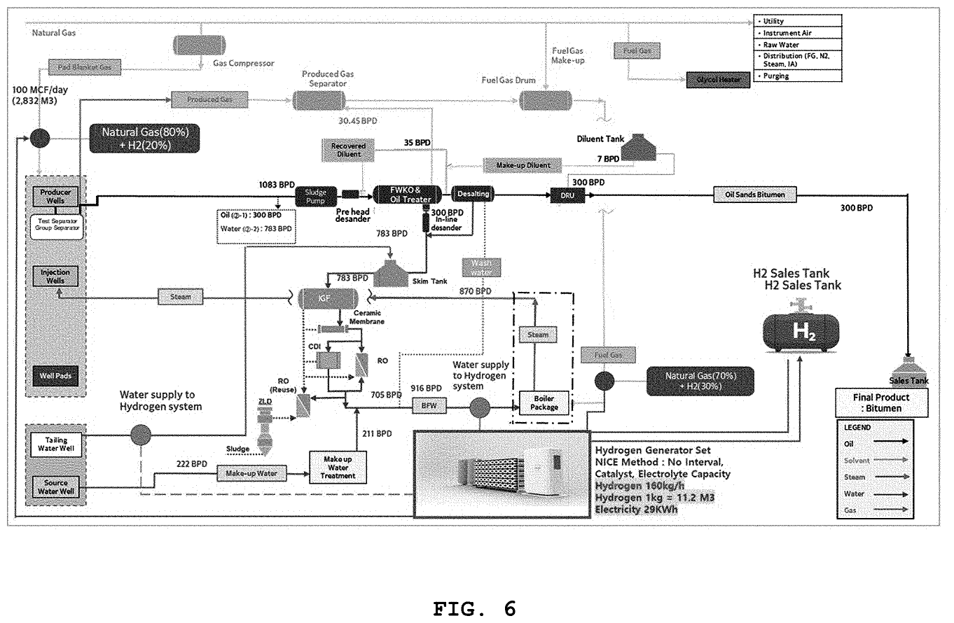

FIGS. 5 and 6 are diagrams of an SAGD production system using hydrogen in accordance with another embodiment of the present invention. FIGS. 5 and 6 show a system configured to use natural gas in the embodiment described with reference to FIGS. 3 and 4 through mixture of natural gas and to substitute, with hydrogen, a solvent used together with steam and natural gas, as in a conventional SAGD system, in a region where production of natural gas is possible in a nearby region or easy use of natural gas is achieved through a gas pipe.

In this system, accordingly, a first water treatment module 101 configured to remove impurities from make-up water, thereby producing purified water, is provided for steam production and hydrogen production. As described above, as the make-up water, source water obtained from a natural environment such as a pond, a water reservoir, a river, etc. and tailing water present in a mining region after treatment of oil sands. The make-up water is treated to remove impurities therefrom through the first water treatment module 101, and then used as boiler fresh water (BFW) and water for hydrogen production through water electrolysis which will be described later. In the embodiment of the present invention, a system in which purified water of 211 barrel per day (BPD) is produced from make-up water of 222 BPD is proposed.

Water obtained from tailing water may be supplied to a skim tank of an oil-water separation module 108 and a hydrogen production module 103, which will be described later, in a divisional manner through a first branching part 118.

In addition, the boiler fresh water (BFW) may be supplied to a boiler module 102 and the hydrogen production module 103 in a divisional manner through a second branching part 119.

Thereafter, purified water obtained after impurities are removed from water passing through the first water treatment module 101 is heated through the boiler module 102, thereby producing steam. Although steam is initially produced only from purified water emerging from the first water treatment module 101, water for production of steam may also be supplied to a second water treatment module 113, as will be described later. In the embodiment of the present invention, water of 211 BPD may be supplied to the first water treatment module 101 and water of 705 BPD may be supplied to the second water treatment module 113, and, as such, water of 916 BPD may be totally supplied for production of purified water for production of steam and hydrogen. In addition, a system design is made to achieve production of steam of 870 BPD through the boiler module 102.

In addition, a part of the purified water obtained after impurities are removed from water passing through the first water treatment module 101 is electrolyzed in the hydrogen production module 103 using electricity, thereby producing hydrogen. For this function, the hydrogen production module 103 is provided with electricity, a catalyst, and a separation membrane for electrolysis of purified water. In this case, competitiveness may be enhanced through application of non-catalytic hydrogen production technology using a recent non-catalytic water electrolysis technology in which an expensive catalyst is not used through use of platinum, iridium, ruthenium, or the like.

In the embodiment of the present invention, 1 kg of hydrogen may be produced using 9 kg of water, and hydrogen may be produced at a rate of 14.5 kg/h using purified water at a rate of 20 bbl/d=132 kg/h in accordance with 1 bbl/d=6.62 kg/h. Accordingly, 162 m³ of hydrogen gas may be supplied using 132 kg of water per hour.

In this case, as electricity for water electrolysis, electricity obtained from renewable energy such as solar power, wind energy, etc. is used. In addition, there is no emission of carbon in the hydrogen production procedure. In this regard, green hydrogen, which is future energy most needed in the carbon neutral era, may be produced. In particular, effects obtained by green hydrogen may be greatly enhanced in accordance with recent lowering of costs of renewable energy. Since the boiler module 102 is configured to use, as fuel, a part of the hydrogen produced in the hydrogen production module 103, the efficiency of the whole system may be enhanced.

A part of the hydrogen produced through the hydrogen production module 103 may be supplied to an inside of the oil sands mining region such that the supplied hydrogen is used as fuel of the boiler module 102. The remaining hydrogen may be stored in an H₂ sales tank to be used for various purposes.

Steam produced through the boiler module 103 is supplied to the inside of the oil sands mining region through an injection well 105, and a part of the hydrogen produced in the hydrogen production module 103 is also supplied to the inside of the oil sands mining region through a hydrogen supplier 104. As described above, steam of 870 BPD and hydrogen of 100 MCF/day (2,832 m³) is supplied to the inside of the oil sands mining region.

Accordingly, recovery of bitumen and gas is performed from a producer well 106 installed at a lower portion of the oil sands mining region. A gas component and bitumen in the producer well 106 are separated from each other through a first separator 107. Here, the bitumen has a state in which an oil component of the bitumen is mixed with water resulting from steam supplied to the oil sands mining region, and the gas component has a state in which hydrogen supplied to the oil sands mining region is mixed with natural gas naturally present in the mining region or separately supplied in a state of being mixed with hydrogen. Since the gas component and the bitumen in the producer well 106 have different states, respectively, the first separator 107 may easily separate the gas component and the bitumen from each other through utilization of the principle of separating gas and non-gas components from each other.

In the embodiment of the present invention, the bitumen separated through the first separator 107 after being recovered from the producer well 106 may have a total amount of 1,083 BPD in a state in which 300 BPD of an oil component and 783 BPD of water are mixed. Accordingly, a water component is separated from the bitumen emerging from the first separator, through the oil-water separation module 108.

For this procedure, the bitumen separated through the first separator 107 is fed through a sludge pump to be supplied to the oil-water separation module 108. In this procedure, sand removal and dehydration may be carried out. In the embodiment of the present invention, the oil-water separation module 108 uses a free water knockout (FWKO). A desalination module 109 is also provided to perform desalination of the water-separated bitumen.

Water separated through the oil-water separation module 108 is treated through the second water treatment module 113 having an induced gas floatation (IGF) configuration, after passing through the skim tank. In addition, the water is supplied to the boiler module 102 and the hydrogen production module 103. In this case, water may be additionally supplied to the skim tank through the first branching part 118.

The IGF means a water treatment process for purifying wastewater through removal of suspended solids such as oil or solids from the wastewater. The IGF includes capacitive deionization (CDI) capable of removing ions through a ceramic membrane filter, a reverse osmosis (RO) filter, or electrical force, and inexpensively and highly efficiently achieving sewage treatment and desalination based on the super capacitor principle. In addition, sludge included in concentrate brine produced in the RO filter may be discharged after treatment through zero liquid discharge (ZLD) technology for recirculating the concentrate brine without discharging as discharged water.

For an enhancement in efficiency of the oil-water separation module 108, a diluent treatment module 114 may be provided. The diluent treatment module 114 includes a diluent tank 115 configured to store a diluent, a diluent supplier 118 configured to supply the diluent to the oil-water separation module 108, and a diluent recovery unit 117 configured to recover a diluent from bitumen emerging from the oil-water separation module 108 and to supply the recovered diluent to the diluent tank 115.

That is, the diluent treatment module 114 supplies the diluent to a backside of a pre-head desander for sand removal and dehydration, recovers the diluent from bitumen emerging from the oil-water separation module 108, and again supplies the recovered diluent. The diluent treatment module 114 may enhance efficiency of separating water from an oil component by up to 97% while circulating the diluent in the above-described manner.

The diluent may be varied in accordance with concrete components of bitumen. In accordance with various forms of hydrocarbon, butene (C₄), pentene (C₅), and hexene (C₆) may be used. The diluent is used in SAGD treatment to assist in effective separation and production of crude oil and water.

That is, in an SAGD method, crude oil is produced in a steam-assisted gravity drainage manner and, as such, includes a considerable amount of water together with steam. For this reason, a mixture of crude oil and water should be treated for separation of crude oil and water. The diluent reduces a boundary surface tension of a fluid on water, thereby promoting separation of the fluid. Accordingly, the diluent more effectively separates water from crude oil and efficiently assists in oil collection. In addition, high viscosity of a fluid may make it difficult for the fluid to flow. In connection with this, the diluent may reduce the viscosity of an impure fluid having a high viscosity, thereby enhancing flow characteristics of the fluid.

In addition, the gas component emerging from the first separator 107 may be used as fuel gas, together with the gas component partially removed through the oil-water separation module 108. In addition, the gas component emerging from the first separator 107 is mixed with natural gas and hydrogen as major components. In connection with this, accordingly, a second separator 110 configured to produce reformed hydrogen using the gas component emerging from the first separator 107 is provided to produce hydrogen. Furthermore, a part of the gas component emerging from the first separator 107 may be used as fuel of the boiler module 102.

When supply of natural gas from the outside is smooth, as described above, a first gas mixing module 111 configured to be connected to the hydrogen supplier, to mix natural gas supplied thereto with hydrogen at a predetermined ratio, and to supply the mixture to the inside of the oil sands mining region, may be provided. Preferably, the natural gas and the hydrogen are mixed in a ratio of 70:30 to 90:10 and, as such, a great enhancement in bitumen recovery efficiency may be achieved.

In addition, a second gas mixing module 112, which is configured to mix the natural gas separated in the second separator 110 and a part of the hydrogen produced in the hydrogen production module in a predetermined ratio and to supply the resultant mixture as fuel of the boiler module, may be further provided, thereby reducing waste of energy and achieving an enhancement in efficiency. In this case, it is preferred that natural gas and hydrogen be mixed in a ratio of 60:40 to 80:20.

Through the system of the present invention as described above, it may be possible to not only reduce greenhouse gas emissions using green hydrogen in an unconventional oil production region that is worst in terms of emissions of greenhouse gases, but also to realize P2G through storage and supply of green hydrogen. In addition, the system of the present invention may be converted into a new unconventional oil production plant capable of producing and using both oil essentially required for industrial purposes and green hydrogen essentially required in future in association with global warming.

When hydrogen is mixed at a rate of 10 vol % in 40 million tons of natural gas, which is annual natural gas consumption in Korea, annual natural gas consumption may be reduced by 1.29 million tons and, as such, annual carbon dioxide reduction of 3.55 million tons may be achieved. In addition, production of nonconventional oil is expected to be greatly reduced in future because current environmental pollution sanctions in nonconventional oil mining regions in Canada and other countries becomes higher. However, through application of the production system using green hydrogen in accordance with the present invention, it may be possible to provide an eco-friendly solution for nonconventional oil production and to greatly enhance the quality of bitumen through characteristics of hydrogen, for example, hydrogenation.

What is claimed is:

1. A carbon reduction type SAGD plant system for recovering bitumen of an oil sands mining region, using green hydrogen, comprising:
a first water treatment module configured to remove impurities from make-up water, thereby producing purified water;
a boiler module configured to heat the purified water, thereby producing steam;
a hydrogen production module configured to electrolyze the purified water using electric power, thereby producing hydrogen;
an injection well configured to supply the steam to an inside of the oil sands mining region;
a hydrogen supplier configured to supply a part of the hydrogen produced in the hydrogen production module to the inside of the oil sands mining region;
a producer well configured to allow recovery of bitumen and gas from a lower portion of the oil sands mining region therein;
a first separator configured to separate a gas component and bitumen in the producer well; and
an oil-water separation module configured to separate a water component from the bitumen emerging from the first separator.

2. The carbon reduction type SAGD plant system according to claim 1, further comprising:
a second separator configured to produce reformed hydrogen using the gas component emerging from the first separator,
wherein the boiler module is configured to use, as fuel, a part of the hydrogen produced in the hydrogen production module.

3. The carbon reduction type SAGD plant system according to claim 1, further comprising:
a first gas mining module configured to receive natural gas from outside, to be connected to the hydrogen supplier, to mix the natural gas and the hydrogen supplied from the hydrogen supplier at a predetermined ratio, and to supply a resultant mixture to the inside of the oil sands mining region; and
a second gas mixing module configured to mix natural gas separated in the second separator and a part of the hydrogen produced in the hydrogen production module at a predetermined ratio, and to supply a resultant mixture as fuel of the boiler module.

4. The carbon reduction type SAGD plant system according to claim 1, further comprising:
a second water treatment module configured to treat water separated in the oil-water separation module and to supply the treated water to the boiler module and the hydrogen production module.

5. The carbon reduction type SAGD plant system according to claim 1, further comprising:
a diluent treatment module comprising a diluent tank configured to store a diluent, a diluent supplier configured to supply the diluent to the oil-water separation module, and a diluent recovery unit configured to recover a diluent from bitumen emerging from the oil-water separation module and to supply the recovered diluent to the diluent tank.
